(19) United States
(12) Patent Application Publication
(10) Pub. No.: US 2013/0283214 A1
(43) Pub. Date: Oct. 24, 2013

(54) APPARATUS AND METHOD FOR PROVIDING USER INTERFACE FOR RECOGNIZING GESTURE

(71) Applicant: Electronics and Telecommunications Research Institute, (US)

(72) Inventors: Jin-Woo KIM, Daejeon (KR); Tae-Man HAN, Daejeon (KR)

(73) Assignee: Electronics and Telecommunications Research Institute, Daejeon-city (KR)

(21) Appl. No.: 13/738,651

(22) Filed: Jan. 10, 2013

(30) Foreign Application Priority Data
Apr. 18, 2012 (KR) 10-2012-0040492

(51) Int. Cl. G06F 3/0481

(52) U.S. Cl. CPC G06F 3/04815
USPC 715/849

(57) ABSTRACT

Disclosed herein is an apparatus and method for providing a user interface for recognizing a user's gesture in virtual or augmented reality. The user interface provision apparatus includes an image provision unit for providing virtual reality to a 3D area. A manipulation recognition unit is represented in the 3D area and recognizes a gesture based on a user experience using a visual contact effect. A processing unit recognizes the gesture and manipulates one or more bubble clouds. Further, the apparatus provides a user interface for menu manipulation and configuration so that a virtual object is held and manipulated in the same manner as when an object is held with the hand or a tool in the real world, rather than the manner in which 3D model control is performed based on recognition of the gesture made by the hand in augmented reality or virtual reality.

### CROSS REFERENCE TO RELATED APPLICATION

This application claims the benefit of Korean Patent Application No. 10-2012-0040492, filed on Apr. 18, 2012, which is hereby incorporated by reference in its entirety into this application.

### BACKGROUND OF THE INVENTION

1. Technical Field

The present invention relates generally to user interfaces and, more particularly, to an apparatus and method for providing a user interface for recognizing a user's gesture in virtual reality or augmented reality.

2. Description of the Related Art

A User Interface (UI) used in conventional three-dimensional (3D) television (TV), augmented reality, or virtual reality has been configured such that a UI used in a two-dimensional (2D) plane is taken without change and is either used in a virtual touch manner or used by moving a cursor.

Further, menus are formed in the shape of icons in augmented reality or virtual reality and are managed in a folder or another screen as an upper level. Further, detailed sub items of the corresponding menu can be viewed either in a drag-and-drop manner or by means of selection. However, conventional technology is disadvantageous in that a 2D array is used in a 3D space or in that even in the 3D space, a tool or a gesture recognition interface is still at the level of the function of replacing a remote pointer or a mouse.

Korean Patent Application Publication No. 2009-0056792 provides technology related to an input interface for augmented reality and an augmented reality system having the user interface, but it has limited characteristics when a user intuitively manipulates menus in a 3D space.

Further, the above patent is problematic in that it is impossible to recognize the user's gestures and execute menus that can be classified into various layers, thus preventing the user from intuitively selecting or executing menus in augmented reality or virtual reality.

### SUMMARY OF THE INVENTION

Accordingly, the present invention has been made keeping in mind the above problems occurring in the prior art, and an object of the present invention is to provide a user interface for recognizing a gesture, which enables a virtual object to be held and manipulated in a user's hand in the same manner as when an object is held in the user's hand or with a tool in the real world.

Another object of the present invention is to provide a user interface having intuition and convenience to a user by making the user experience, pertaining to a method of touching and manipulating an object in the real world and a method of manipulating an object in virtual reality or augmented reality, identical.

A further object of the present invention is to provide a user interface, which can effectively manage a large amount of data using a 3D space based on the concept of a bubble cloud.

In accordance with an aspect of the present invention to accomplish the above objects, there is provided an apparatus for providing a user interface for recognizing a gesture, including an image provision unit configured to provide virtual reality to a three-dimensional (3D) area, a manipulation recognition unit represented in the 3D area and configured to recognize a gesture based on a user experience realized using a visual contact effect, and a processing unit for recognizing the gesture and manipulating one or more bubble clouds.

Preferably, the image provision unit may provide a bubble layer including the one or more bubble clouds, and a bubble external layer for allowing a desired bubble cloud to be selected from among the one or more bubble clouds by searching the bubble layer.

Preferably the one or more bubble clouds may be classified into a plurality of layers, and a bubble cloud in a lower layer may be included in a bubble cloud in an upper layer.

Preferably, the manipulation recognition unit may recognize a gesture of one hand or both hands and then allow the processing unit to manipulate the one or more bubble clouds.

Preferably, the processing unit may move the bubble cloud in the lower layer either into the bubble cloud in the upper layer or out of the bubble cloud in the upper layer depending on the gesture recognized by the manipulation recognition unit.

Preferably, the processing unit may be capable of merging two or more bubble clouds belonging to the one or more bubble clouds depending on the gesture recognized by the manipulation recognition unit.

In accordance with another aspect of the present invention to accomplish the above objects, there is provided a method of providing a user interface for recognizing a gesture, the method being performed by an apparatus for providing the user interface for recognizing the gesture, including searching for one or more bubble clouds by rotating a three-dimensional (3D) area including the one or more bubble clouds in compliance with a gesture or a voice command, selecting a bubble cloud corresponding to the gesture from among the one or more bubble clouds, zooming in or zooming out the selected bubble cloud according to a gesture corresponding to a zoom-in or zoom-out operation, recognizing the selected bubble cloud based on a user experience realized using a visual contact effect, and manipulating the recognized bubble cloud by moving or rotating the bubble cloud depending on the gesture.

Preferably, the method may further include causing the recognized bubble cloud to be included in some other bubble cloud, or merging the recognized bubble cloud with the other bubble cloud, thus managing the bubble clouds.

Preferably, the one or more bubble clouds may be manipulated or managed by a gesture of one hand or both hands.

Preferably, the one or more bubble clouds may be classified into a plurality of layers, and a bubble cloud in a lower layer may be included in a bubble cloud in an upper layer.

Preferably, the managing the bubble clouds may be configured to move the bubble cloud in the lower layer either into the bubble cloud in the upper layer or out of the bubble cloud in the upper layer depending on the gesture, and to merge two or more bubble clouds belonging to the one or more bubble clouds depending on the gesture.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram showing bubble clouds based on layers according to an embodiment of the present invention;

FIG. 2 is a conceptual diagram showing the management of bubble clouds according to an embodiment of the present invention;

FIG. 3 is a conceptual diagram showing the movement of a bubble cloud according to an embodiment of the present invention;

FIG. 4 is a conceptual diagram showing the merging of bubble clouds according to an embodiment of the present invention;

FIG. 5 is a block diagram showing the configuration of an apparatus for providing a user interface according to an embodiment of the present invention; and

FIG. 6 is a flowchart showing a method of providing a user interface according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, preferred embodiments of the present invention will be described in detail with reference to the attached drawings.

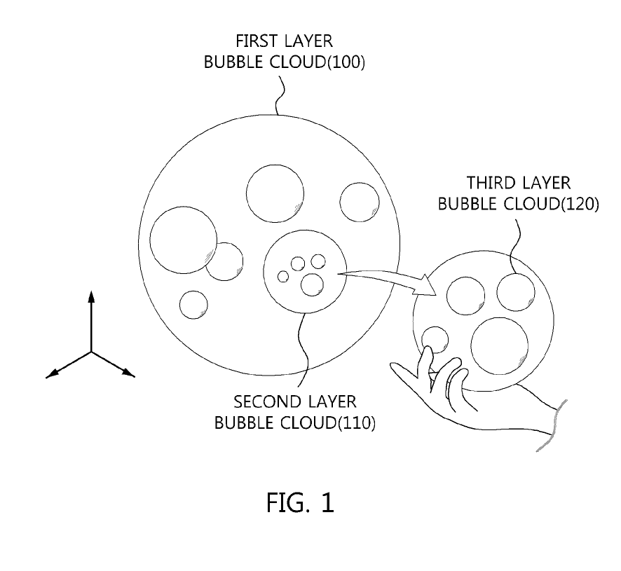

FIG. 1 is a conceptual diagram showing bubble clouds based on layers according to an embodiment of the present invention.

Referring to FIG. 1, a bubble User Interface (UI) according to an embodiment of the present invention is the concept of a UI that is usable when an interface having a visual contact effect on a virtual 3D object is used in virtual reality or augmented reality on the basis of a user experience touching and transferring an object floating in the air in a weightless state in the real world.

In addition, the concept of the UI presented in the present invention can provide the user with the sensation of being able to manipulate an object of the real world in a virtual world by combining the physical concept of an actual soap bubble with the 3D information of a 3D model in the virtual world.

Therefore, the user interface for recognizing a gesture according to the present invention includes a 3D area that provides virtual reality, and at least one bubble cloud that is represented in the 3D area and that is manipulated depending on the gesture based on a user experience realized using a visual contact effect. Here, the bubble cloud may denote a single bubble, a set of bubbles, a bubble item, a menu, a set of menus, an icon, or a set of icons.

In FIG. 1, bubble clouds may be classified into a plurality of layers. A first layer bubble cloud 100 may be present in an upper layer higher than that of a second layer bubble cloud 110, and the second layer bubble cloud 110 may be present in an upper layer higher than that of a third layer bubble cloud 120. For example, the first layer bubble cloud 100 may include at least one second layer bubble cloud 110, and the second layer bubble cloud 110 may include at least one third layer bubble cloud 120. Further, the first layer bubble cloud 100 belonging to the upper layer may perform a function identical to that of a folder, and the third layer bubble cloud 120 belonging to the lower layer may function as a bubble, an icon or a menu indicating a single item. That is, one or more bubble clouds may be classified into a plurality of layers, and a bubble cloud in a lower layer may be included in a bubble cloud in an upper layer.

In FIG. 1, the user interface according to an embodiment of the present invention provides a user with the sensation of holding a bubble cloud based on a virtual contact effect using the user's hand or a tool, thus allowing the user to freely move the bubble cloud. The bubble cloud can be controlled not only with just one hand but also with both hands For this operation, the user interface must have 3D information in an environment in which 3D reconstruction and camera rotation are set. That is, at least one bubble cloud can be manipulated by the gesture of one hand or both hands.

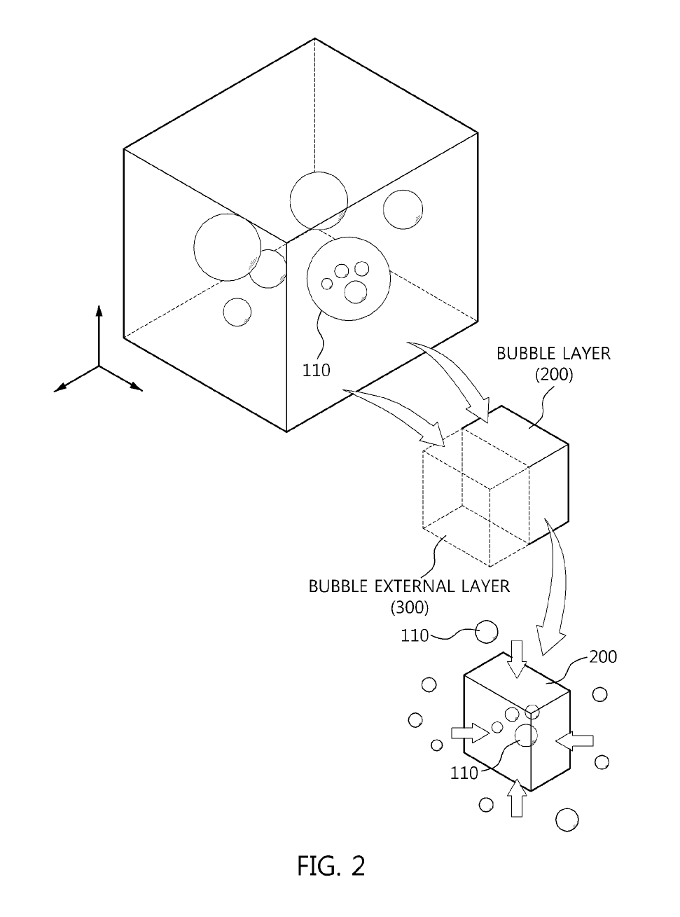

FIG. 2 is a conceptual diagram showing the management of bubble clouds according to an embodiment of the present invention.

Referring to FIG. 2, a user interface according to an embodiment of the present invention provides a User eXperience (UX) that is usable when a bubble cloud or a bubble in a lower layer is transferred into the first layer bubble cloud 100, or is inversely transferred to the outside of the first layer bubble cloud 100.

For example, the bubble cloud or the bubble in the lower layer is transferred into the first layer bubble cloud 100 or is inversely transferred to the outside of the first layer bubble cloud 100, thus enabling a new application program corresponding to the bubble cloud or the bubble to be downloaded or transferred via an Application store (App Store), a web, or another storage.

The user interface for recognizing a gesture enables a bubble present outside a highest layer bubble cloud to be picked up and put into the highest layer bubble cloud using a user's hand or a virtual tool, thus allowing the user to perform intuitive manipulation in the 3D space.

FIG. 2 illustrates a method of bringing a new bubble into a usable bubble cloud area. A bubble layer 200 is an area in which an actual bubble and an actual bubble cloud are present. A bubble external layer 300 is a 3D area that allows the user to select a desired bubble or a desired bubble cloud by performing camera rotation on the entire bubble cloud using a gesture or the like outside the bubble, or by utilizing a pointing gesture or a voice command. That is, the user can bring the bubble cloud or the bubble into the area of the bubble layer 200 and can use the bubble cloud or the bubble brought into the area of the bubble layer 200.

Therefore, the 3D area may include a bubble layer 200 including one or more bubble clouds, and a bubble external layer 300 for allowing a desired bubble cloud to be selected from among the one or more bubble clouds by searching the bubble layer 200.

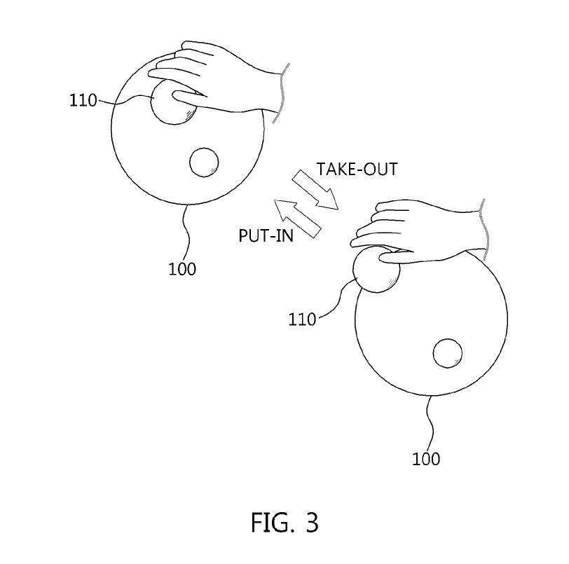

FIG. 3 is a conceptual diagram showing the movement of a bubble cloud according to an embodiment of the present invention.

Referring to FIG. 3, a user can hold a bubble or an icon present in the third layer bubble cloud 120 and put it into another bubble cloud using the user's hand or a tool, such as clamps. This is identical to the concept of putting a soap bubble into another soap bubble in a 3D space. That is, the present invention provides the user with intuition that enables a soap bubble having a physical property in a weightless state to be easily manipulated with the user's hand or the tool.

As shown in FIG. 3, the user can put the third layer bubble cloud 120 into the second layer bubble cloud 110 or take it out of the second layer bubble cloud 110 using the hand or the tool. That is, the user can manage bubble clouds by intuitively moving bubble clouds belonging to different layers using the hand or the tool.

Therefore, a bubble cloud in a lower layer can be moved into a bubble cloud in an upper layer or out of the bubble cloud in the upper layer depending on the gesture.

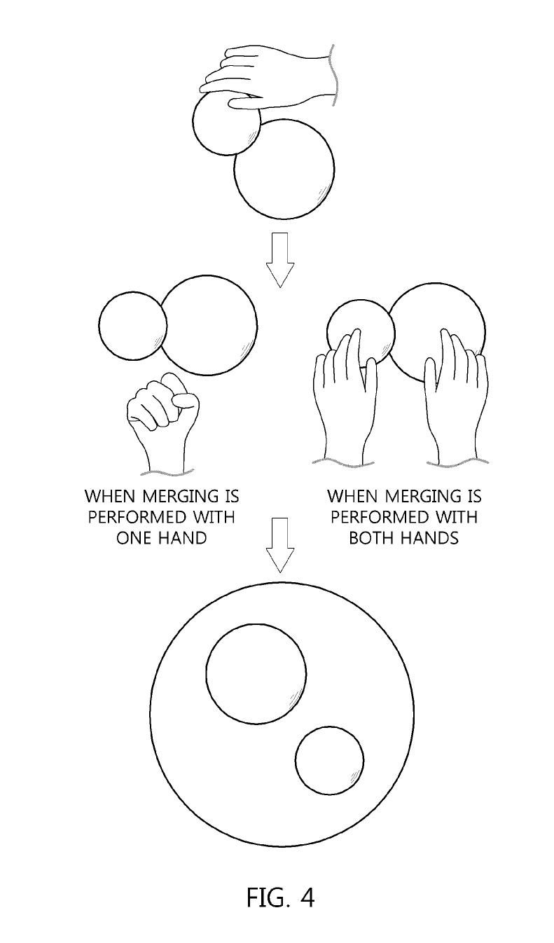

FIG. 4 is a conceptual diagram showing the merging of bubble clouds according to an embodiment of the present invention.

Referring to FIG. 4, the user interface for recognizing a gesture according to an embodiment of the present invention allows a user to merge bubble clouds using one hand or both hands.

When desiring to include contents of any one bubble in the contents of another bubble, the user may merge the one bubble into the remaining bubble if he or she holds one bubble with one hand and brings it to a desired bubble into which the bubble is to be merged, and then takes the action of breaking the bubble (with the user's fist).

In this case, when each bubble is an item, another bubble including the two items is generated. Further, when two bubbles are bubble clouds, each including an item, the item of a bubble that was held in the hand is put into a desired bubble into which the corresponding bubble is to be merged, as shown in FIG. 4.

Upon merging bubbles or bubble clouds, both the cases when they are merged with one hand and when they are merged with two hands can be used. In the case where bubbles or bubble clouds are merged with two hands, bubbles are respectively held in two hands and joined together. Even in this case, a bubble that has been pressed by more motions can be merged into the other bubble, similarly to the case where one hand is used. That is, two or more bubble clouds belonging to one or more bubble clouds can be merged depending on the gesture.

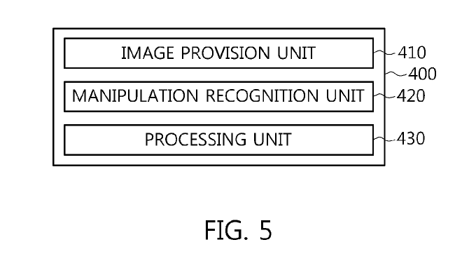

FIG. 5 is a block diagram showing the configuration of an apparatus for providing a user interface according to an embodiment of the present invention.

Referring to FIG. 5, an apparatus 400 for providing a user interface according to an embodiment of the present invention includes an image provision unit 410, a manipulation recognition unit 420, and a processing unit 430.

The image provision unit 410 can provide virtual reality to a 3D area. In order to provide augmented reality or virtual reality to the 3D space, a Head Mounted Display (HMD), an Eye Glass Display (EGD), or the like can be used. For example, the image provision unit 410 can provide a bubble layer including one or more bubble clouds, and a bubble external layer for enabling a desired bubble cloud to be selected from among the one or more bubble clouds by searching the bubble layer.

The manipulation recognition unit 420 is represented in the 3D area, and is capable of recognizing a gesture based on a user experience realized using a visual contact effect. In accordance with an embodiment of the present invention, the manipulation recognition unit 420 can recognize the gesture of the user using a camera, an infrared detection sensor, or any of other various types of sensors, and is not especially limited to a specific type in the present invention. For example, the manipulation recognition unit 420 can manipulate one or more bubble clouds by recognizing the gesture of one hand or both hands.

The processing unit 430 can manipulate one or more bubble clouds depending on the gesture recognized by the manipulation recognition unit 420. The processing unit 430 can process information about the gesture recognized by the manipulation recognition unit, and can control the image provision unit based on the processed information. For example, the processing unit 430 may be either a microprocessor (MPU) or a microcomputer (MCU). Further, the processing unit 430 can move a bubble cloud in a lower layer into a bubble cloud in an upper layer, or out of the upper layer bubble cloud, depending on the gesture. Furthermore, the processing unit 430 can merge two or more bubble clouds belonging to one or more bubble clouds depending on the gesture.

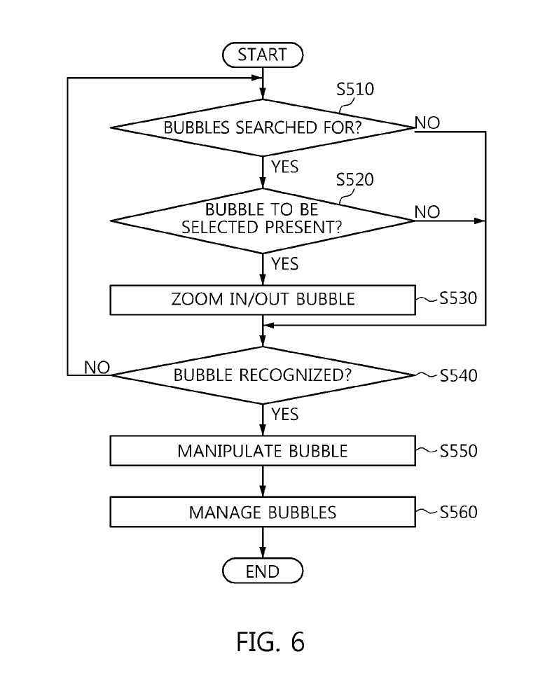

FIG. 6 is a flowchart showing a method of providing a user interface according to an embodiment of the present invention.

Referring to FIG. 6, the method of providing a user interface for recognizing a gesture according to an embodiment of the present invention includes the step of searching for one or more bubble clouds by rotating a 3D area including the one or more bubble clouds in compliance with a gesture or a voice command, the step of selecting a bubble cloud corresponding to the gesture from among the one or more bubble clouds, the step of zooming in or zooming out the selected bubble cloud in compliance with a gesture corresponding to a zoom-in or zoom-out operation, the step of recognizing the selected bubble cloud based on a user experience realized using a visual contact effect, and the step of manipulating the bubble cloud by moving or rotating the recognized bubble cloud depending on the gesture.

The step of searching for bubble clouds can be configured to search for one or more bubble clouds by rotating the camera or an axis at step S510. That is, the user can search for a desired bubble while rotating bubble items or bubble clouds augmented in the 3D space at an angle of 360 degrees without coming into contact with the bubble items or the bubble clouds at either a long or short distance. The user interface used in this case may include rotation based on a gesture and rotation based on a voice command. These two types of commands may be merged in a multi-model form, or coexist in independent forms. For example, when the bubble items or bubble clouds are turned left and right by recognizing the gesture and then are rotated in a vertical direction in compliance with a voice, the user interface can recognize the latest command.

The step of selecting the bubble cloud may be configured to visually search for a desired bubble and select the bubble cloud using a voice or a pointing gesture at step S520. That is, after searching for the bubble clouds, or when the user interface is first initiated, the user can bring bubble clouds, which are located a short or long distance away and which come into sight, close to the user in compliance with a pointing command, without having to go through the searching step based on rotation. The pointing command is configured such that the fingers or hands are folded and can be selected as a single direction vector or, alternately, pointing can be performed using a tool. Further, the pointing command can be configured to select a desired bubble by designating the identification (ID) or name of the bubble using a voice command.

At the step of zooming in or zooming out the bubble cloud, the selected bubble cloud can be observed using zoom in/out operations using a camera view at step S530. That is, the selected long-distance bubble cloud is viewed close to the user to zoom in, and can be actually copied to and moved in a direction close to the user, with 3D depth information contained in the bubble cloud. In this case, the user can manipulate and use a 3D bubble item or bubble cloud that has been drawn close to the user, and can thereafter return it to its original position or maintain it at the current position drawn close to the user.

The step of recognizing the bubble cloud may be configured to recognize that the user held the bubble with the hand or a tool based on a visual contact effect at step S540. That is, the case when the bubble cloud that has been drawn close to the user returns to its original position and the case when the bubble cloud is maintained at the current position can be discriminated from each other. When the bubble cloud has returned to its original position, it returns to the original position if the user carries out the actions of touching the bubble cloud that has been drawn close to the user using a single finger or a tool enabling a single contact point to be recognized, checking the contents of the bubble cloud, terminating the checking, and thereafter pushing the bubble cloud in the depth direction. Meanwhile, when it is desired to maintain the bubble cloud that has been drawn close to the user at the current location, the user can check the contents of the bubble cloud while holding the bubble cloud in his or her hand. However, even if the user holds the bubble cloud in his or her hand, checks the contents of the bubble cloud, and then terminates the checking, the bubble cloud can return to its original position if it is pushed in the depth direction using a user interface having a single contact point.

The step of manipulating the bubble cloud is configured to manipulate the held bubble cloud by moving or rotating the bubble cloud at step S550. That is, the bubble cloud held with the hand or the tool can be manipulated with one hand or both hands. The bubble cloud being in a contact state can be subjected to operations, such as movement, rotation, and bubble realignment, using one hand or both hands.

The step of managing the bubble clouds is configured to move a bubble cloud into or out of another bubble cloud or merge bubble clouds, thus managing the bubble clouds at step S560. That is, with regard to the bubble cloud held in one hand or both hands, bubble items from a single bubble cloud can be brought close to another bubble cloud using operations, such as merging, putting in or taking out bubble clouds, and a plurality of bubble menus can be efficiently managed based on such operations.

Therefore, a bubble cloud in a lower layer can be moved into a bubble cloud in an upper layer or moved out of the upper layer bubble cloud depending on the gesture, and two or more bubble clouds belonging to one or more bubble clouds can be merged depending on the gesture.

Further, the one or more bubble clouds can be manipulated or managed depending on the gesture of one hand or two hands.

In this case, the one or more bubble clouds can be divided into a plurality of layers, wherein a bubble cloud in a lower layer can be included in a bubble cloud in an upper layer.

The above-described apparatus for providing a user interface for recognizing a gesture according to the present invention provides a user interface for menu manipulation and configuration so that a virtual object is held and manipulated in the same manner as when an object is held with the hand or a tool in the real world, rather than the manner in which 3D model control is performed based on the recognition of the gesture made by the hand in augmented reality or virtual reality in a 3D space.

Further, the above-described individual steps can be performed in real time in the user interface, and functions thereof can be independently performed.

Therefore, the user interface according to the embodiment of the present invention is intended to provide intuition and convenience by making user experiences, related to a method of touching and manipulating an object in the real world and a method of manipulating an object in virtual reality or augmented reality, identical. For this, the bubble UI presented in the present invention can efficiently and effectively manage a large amount of data in a 3D space based on the concept of a bubble present inside a bubble.

Furthermore, the user interface according to the embodiments of the present invention can also provide a UI represented in 2.5D on a 2D touch-based display, and can be applied to a UI based on a device, such as a Head Mounted Display (HMD) or an Eye Glass Display (EGD), in a 3D space for augmented reality or virtual reality. Since a bubble cloud can be present inside another bubble cloud and bubble clouds can be rotated around a single axis, the bubble clouds can function as an effective 3D virtual folder instead of a plurality of existing streams or a UI represented by icons in the 3D space.

Furthermore, the user experience (UX) that allows the user to personally hold required contents, present in a bubble cloud floating in the air, with the hand in the real world, to put the contents into an upper layer bubble cloud, and to pick up and take the bubble cloud out of the upper layer bubble cloud can provide an intuitive interface in the 3D space.

Therefore, the apparatus for providing the user interface for recognizing a gesture according to the embodiments of the present invention overcomes the restriction of a monitor-based PC environment and can be applied to devices, such as an HMD or an EGD, not only using augmented realty and virtual reality but also using mobile or portable devices.

In accordance with the present invention, a virtual object can be held and manipulated in a user's hand in the same manner as when an object is held in the user's hand or with a tool in the real world.

Further, the present invention can provide intuition and convenience to a user by making the user experience, pertaining to a method of touching and manipulating an object in the real world and a method of manipulating an object in virtual reality or augmented reality, identical.

Furthermore, the present invention can effectively manage a large amount of data using a 3D space based on the concept of a bubble cloud.

As described above, in the apparatus and method for providing a user interface for recognizing a gesture according to the present invention, the configurations and schemes in the above-described embodiments are not limitedly applied, and some or all of the above embodiments can be selectively combined and configured so that various modifications are possible.

What is claimed is:

1. An apparatus for providing a user interface for recognizing a gesture, comprising:
an image provision unit configured to provide virtual reality to a three-dimensional (3D) area;
a manipulation recognition unit represented in the 3D area and configured to recognize a gesture based on a user experience realized using a visual contact effect; and
a processing unit for recognizing the gesture and manipulating one or more bubble clouds.

2. The apparatus of claim 1, wherein the image provision unit provides:
a bubble layer including the one or more bubble clouds; and
a bubble external layer for allowing a desired bubble cloud to be selected from among the one or more bubble clouds by searching the bubble layer.

3. The apparatus of claim 1, wherein the one or more bubble clouds can be classified into a plurality of layers, and a bubble cloud in a lower layer is included in a bubble cloud in an upper layer.

4. The apparatus of claim 1, wherein the manipulation recognition unit recognizes a gesture of one hand or both hands and then allows the processing unit to manipulate the one or more bubble clouds.

5. The apparatus of claim 3, wherein the processing unit moves the bubble cloud in the lower layer either into the bubble cloud in the upper layer or out of the bubble cloud in the upper layer depending on the gesture recognized by the manipulation recognition unit.

6. The apparatus of claim 3, wherein the processing unit is capable of merging two or more bubble clouds belonging to the one or more bubble clouds depending on the gesture recognized by the manipulation recognition unit.

7. A method of providing a user interface for recognizing a gesture, the method being performed by an apparatus for providing the user interface for recognizing the gesture, comprising:
searching for one or more bubble clouds by rotating a three-dimensional (3D) area including the one or more bubble clouds in compliance with a gesture or a voice command;
selecting a bubble cloud corresponding to the gesture from among the one or more bubble clouds;
zooming in or zooming out the selected bubble cloud according to a gesture corresponding to a zoom-in or zoom-out operation;
recognizing the selected bubble cloud based on a user experience realized using a visual contact effect; and
manipulating the recognized bubble cloud by moving or rotating the bubble cloud depending on the gesture.

8. The method of claim 7, further comprising causing the recognized bubble cloud to be included in some other bubble cloud, or merging the recognized bubble cloud with the other bubble cloud, thus managing the bubble clouds.

9. The method of claim 8, wherein the one or more bubble clouds are manipulated or managed by a gesture of one hand or both hands.

10. The method of claim 7, wherein the one or more bubble clouds can be classified into a plurality of layers, and a bubble cloud in a lower layer is included in a bubble cloud in an upper layer.

11. The method of claim 9, wherein the managing the bubble clouds is configured to move the bubble cloud in the lower layer either into the bubble cloud in the upper layer or out of the bubble cloud in the upper layer depending on the gesture, and to merge two or more bubble clouds belonging to the one or more bubble clouds depending on the gesture.
